(19) United States
(12) Patent Application Publication
(10) Pub. No.: US 2026/0116115 A1
(43) Pub. Date: Apr. 30, 2026

(54) SECURITY ELEMENT HAVING A MOTIF-FORMING LIQUID-CRYSTAL LAYER

(71) Applicant: Giesecke+Devrient Currency Technology GmbH, Munich (DE)

(72) Inventors: Bjorn TEUFEL, Gmund am Tegernsee (DE); Josef SCHINABECK, Gmund am Tegernsee (DE); Andreas RAUCH, Gmund am Tegernsee (DE); Winfried HOFFMULLER, Gmund am Tegernsee (DE)

(21) Appl. No.: 19/366,030

(22) Filed: Oct. 22, 2025

(30) Foreign Application Priority Data
Oct. 25, 2024 (DE) 102024131191.6

(51) Int. Cl. B42D 25/328

(52) U.S. Cl. CPC B42D 25/328

(57) ABSTRACT

A security element is arranged to safeguard valuable articles, featuring a motif layer based on a liquid-crystal material that forms a latent motif. The security element includes a first embossing varnish layer on a carrier film, with a motif layer partly on this varnish, based on nematic liquid crystals. A second embossing varnish layer covers the surface. The facing surface of the first varnish has an embossing with at least two regions featuring different alignment structures, creating a second latent motif. These alignment structures include an aperiodic grating with varying grid spacing. The motif layer, forming a first latent motif, overlaps the second latent motif regions. The nematic liquid-crystal material is aligned by the motif-forming regions, producing a discernible motif when viewed through a polarizer. The second varnish layer also has an embossing for a micro-optical relief structure and reflection-enhancing coating.

### BACKGROUND

The invention relates to a security element for safeguarding articles of value, having a motif layer based on a liquid-crystal material, which is designed and intended to form a latent motif. The invention furthermore relates to an associated manufacturing process and to a data carrier comprising such a security element.

Data carriers, such as documents of value or identity documents, but also other articles of value, such as branded articles, are often provided, for safeguarding purposes, with security elements that make it possible to check the authenticity of the data carriers and at the same time serve as protection against unauthorized reproduction. Security elements with a viewing angle-dependent or three-dimensional appearance play a particular role in safeguarding authenticity, since they are unable to be reproduced even with the most modern copying machines.

In many cases, the special properties of liquid-crystal materials are also exploited, especially the viewing angle-dependent colour impression and/or the light-polarizing effect of the liquid crystals.

Such materials are practically invisible after they have been applied to a carrier, but exhibit pronounced visual optical effects in the case of an appropriate substrate, for example a reflective print carrier, and when using linear or circular polarizers. The coated regions become more or less optically pronounced only when viewed through a linear or circular polarizer. The imprints may in this case also be highly dependent on the (angular) position of the polarizer.

The processes used here are based for example on the fact that the nematic liquid-crystal layer is provided above a reflective metal layer in order to enable good discernibility of the polarization effects. Document WO 2005/105475 A1 describes a process in which the nematic liquid-crystal material, for example a solvent-based UV-crosslinkable liquid-crystal varnish, is printed onto a carrier film in a pattern.

Due to their internal structure, the plastic carrier films used in these processes have a preferred direction (in the running direction) that is sufficient to align the liquid-crystal material in the desired shape. Particularly suitable are plastic films having a surface structure that is formed during manufacture, such as PET films for example.

A UV-curable embossing varnish layer is then printed over the entire surface of the carrier film and the nematic layer in a further working step. A desired embossing structure, for ex-ample a diffraction structure, is embossed into the embossing varnish layer, and a reflective layer, for example in the form of a metal layer, is applied, in particular vapour-deposited, into which recesses are able to be introduced by partial demetallization. Finally, for transfer to a target substrate (for example paper), an adhesion-promoting or primer layer and, on this, an adhesive layer is applied to the layer composite.

Seen from above, this results in the following layer sequence: nematic liquid crystals, UV varnish (with embossing structure), metallization. The optical effect to be observed in connection with nematic liquid crystals is based on the formation of an optically anisotropic layer or lay-er that influences the polarization of light. When viewed without aids, the layer composite therefore only shows the optically variable diffraction structures provided by the embossing structure, such as holograms. If, on the other hand, it is viewed through a circular polarization filter, then additional structures appear. Regions with a metallization and without a nematic liquid-crystal layer appear black or at least dark, while regions with nematic liquid crystals take on a bright appearance. A horizontal rotation of the circular polarization filter does not cause any change in contrast here.

The operation of a circular polarizer is explained below with reference to the example of metal layers. FIG. 4 shows a schematic illustration of a circular polarizer in this regard. This consists of a first layer in the form of a linear polarization filter and a second layer in the form of a quarter-wave layer or of a “quarter-wave plate” rotated by 45° relative to the polarization filter. When isotropic light then impinges on the circular polarizer, the first layer, which acts as a linear polarization filter, transmits only linearly polarized light. The transmitted linearly polarized light impinges on the quarter-wave layer which is rotated by 45° relative to the linear polarization filter and converts the linearly polarized light into circularly polarized light. The circularly polarized light is in turn reflected from the metal surface and converted, by the second layer, into linearly polarized light with a polarization plane rotated by 90°. Since the first layer does not transmit the light, which now has a rotated polarization plane, metal layers appear dark when they are viewed with a circular polarizer.

As an alternative to viewing with a circular polarization filter, the structures may also be made visible with a linear polarization filter (or a circular polarization filter viewed through the rear, that is to say “reversed”). In this case, the metal-coated regions without a liquid-crystal coating always appear bright. In the regions additionally provided with the nematic liquid-crystal material, suitable horizontal rotation of the linear polarization filter makes it possible to produce either a dark impression that contrasts the regions without the nematic layer, or the regions exhibit a bright appearance without any perceptible contrast in relation to the surrounding metallized regions.

An impression that contrasts the regions without a nematic layer arises here as described be-low with reference to the example of a layer of nematic liquid-crystal material in the form of a quarter-wave plate.

The (isotropic) light that impinges on a linear polarization filter leaves it as linearly polarized light. If it impinges on the quarter-wave plate made of nematic liquid-crystal material at a 45° angle, the linearly polarized light is converted to circularly polarized light. If it impinges on a reflector, for example in the form of a metal layer, circularly polarized light is reflected and impinges again on the quarter-wave plate. After passing through the quarter-wave plate, it is converted to linearly polarized light, but the polarization plane is rotated by 90°. It impinges on the linear polarization filter, which blocks the light, which has now been rotated by 90° in its polarization plane, with the result that the region thereby formed under the polarization filter appears dark.

A dark appearance is thus obtained firstly when a circular polarizer (FIG. 4) is applied to a reflective, in particular metal layer, and secondly when the quarter-wave layer of nematic liquid-crystal material assumes the function of the quarter-wave plate in the circular polarizer.

Liquid-crystal layers manufactured from a solvent-containing formulation are generally difficult to apply at high resolution, since it would be necessary to print significant wet film thicknesses that, due to the low viscosity of the formulations, exhibit a significant flow after printing.

For optimal contrast, the nematic liquid-crystal layer forms a quarter-wave layer for light from the intended wavelength range. Depending on the birefringent properties of the liquid-crystal molecules, this requires a certain layer thickness (order of magnitude of 1 g/m2), meaning that it is not possible to carry out printing at an arbitrarily thin level. The addition of thickeners generally leads to a loss of quality in terms of the optical properties of the liquid-crystal layers.

Optically anisotopic films in the optical path may likewise reduce the contrast able to be achieved, meaning that releasability from the carrier film is advantageous. Very thin UV-crosslinked (liquid-crystal) layers often have poor releasability, however.

In general, solvent-based liquid-crystal varnishes require conditions that promote alignment in order to be able to realize their effect. In other processes, special alignment layers are used for this purpose. Use is made in particular of alignment layers that consist of a linear photo-polymer, which is exposed to suitable radiation for alignment purposes. Liquid-crystal mate-rials may furthermore also be aligned with the aid of alignment layers that are provided by a finely structured layer or a layer that is aligned through the exertion of shear forces.

If for example an aligning embossing structure with two different orientations is coated with nematic liquid-crystal material, the resulting alignment of the liquid crystals, which differs by region, means that the embossing motif is able to be made visible in positive or negative contrast with a linear polarization filter (by rotating the polarization filter). A circular polarization filter, on the other hand, cannot be used to discern a motif.

Use is also made of security elements with latent images, in which the liquid-crystal layer is based on a liquid-crystal mixture containing dichroic dyes, as described for example in document WO 2019/068655 A1. The liquid-crystal mixture is printed here onto an embossing varnish layer provided with an embossing, and is likewise embossed as part of an embossing process. The liquid crystals are in this case aligned independently of one another at both interfaces. Together with the dichroic dye, this creates security features that show different, mutually independent motifs on both sides, these motifs being able to be made visible by being irradiated with linearly polarized light. A similar approach is described in document EP 4 129 709 A1, in which the liquid-crystal layer contains a dichroic dye whose absorption of polarized light depends on its orientation (in relation to the orientation of the polarization of the incident polarized light). When illuminated with polarized light, this allows for the creation of transparent security features. Embossing on both sides may lead to flattening out of the uncured material, and thus to undefined motifs.

Taking this as a basis, the invention is based on the object of providing a security element of the type mentioned at the outset that avoids the disadvantages of the prior art, is easy and inexpensive to manufacture and, in addition to an attractive appearance, exhibits increased protection against counterfeiting.

### SUMMARY

According to the invention, provision is made, in the case of a generic security element, for the latter to comprise a first embossing varnish layer arranged on a carrier film, a motif layer that is partially present on the first embossing varnish layer and is based on a nematic liquid-crystal material, and a single-layer or multilayer second embossing varnish layer present over the whole surface.

The surface of the first embossing varnish layer that faces the nematic liquid-crystal material is provided here with an embossing that has at least two regions with alignment structures having a different orientation so as to form a second latent motif. In this case, at least one of the alignment structures of the motif-forming regions forms a grating pattern comprising grid lines the spacing between which varies over the surface of the motif-forming region, such that the alignment structure forms an aperiodic grating.

The motif layer is arranged, in the form of a first latent motif, in regions, directly on the first embossing varnish layer and so as to overlap the regions forming the second latent motif, wherein the nematic liquid-crystal material is aligned homogeneously by the motif-forming regions in the form of the second latent motif with a respective different orientation, such that the motif formed by the different alignment structures is discernible when viewed through a polarizer.

The second embossing varnish layer is provided with an embossing for producing a micro-optical relief structure and a reflection-enhancing coating.

The layer of nematic liquid-crystal material has polarization-dependent optical effects that cannot be perceived by the eye, but are able to be detected using aids, for example using linear or circular polarization filters, in particular are able to be made visible to the eye of the viewer using such aids.

The varying spacing according to the invention between the grid lines ensures that, despite the small dimensions of the grid lines, no diffraction pattern is superimposed on the representation of the security element in the regions of the nematic liquid-crystal material.

Unlike a periodic arrangement, in the case of an aperiodic arrangement of the grid lines, there is no simple, regular relationship between the spacings between adjacent grid lines. This reliably prevents constructive interference of the light reflected at adjacent grid lines, and thus the formation of a superimposed diffraction pattern, in particular in the regions of the nematic liquid-crystal material.

It has also become apparent that the aligning properties of the alignment structures are not affected by the aperiodic arrangement present in the form of a variation of the spacings.

Preferably, the spacing between the grid lines varies in line with a random number distribution or a pseudorandom number distribution. Pseudorandom numbers are sequences of numbers that appear random, but are calculated by a deterministic algorithm and are therefore not true random numbers in the strict sense. Nevertheless, pseudorandom numbers are widely used since the statistical properties of a pseudorandom number distribution, such as equiprobability of the individual numbers or the statistical independence of successive numbers, are generally sufficient for practical purposes, and pseudorandom numbers are easy to generate using computers, in contrast to true random numbers. A pseudorandom number distribution is always aperiodic in the sense of the present application, since there is no fixed, constant spacing (“period”) between successive values in a pseudorandom number distribution.

An aperiodic variation of the spacing between the grid lines is not limited to pseudorandom number distributions, however, but rather may also be achieved using another irregular spacing distribution.

In one advantageous embodiment, all alignment structures of the motif-forming regions each form a grating pattern comprising grid lines the spacing between which varies over the sur-face of the motif-forming region, such that the alignment structure forms an aperiodic grating.

Advantageously, the alignment structures are in the form of fine grooves or channels by way of which the molecules of the nematic liquid-crystal material are aligned.

For optimal contrast, the motif layer advantageously forms a quarter-wave layer for light from the intended wavelength range. Depending on the birefringence of the liquid-crystal molecules, this requires a certain layer thickness (order of magnitude of 1 g/m2).

In one advantageous embodiment, the aperiodic grating has an average period length of 0.2 μm to 2.0 μm, preferably of 350 nm to 800 nm, and a profile depth of 50 nm to 600 nm, preferably of 200 nm to 400 nm.

Advantageously, the embossing of the first embossing varnish layer for forming the second latent motif has two regions with alignment structures having different orientation directions, wherein the orientation directions assume angles relative to one another selected from the group consisting of 45° and 135°.

The first embossing varnish layer is preferably present over the whole surface. At least in the region of the motif layer, it advantageously does not have any regions without structures that promote the alignment of the liquid-crystal material.

Advantageously, the refractive index of the first and/or of the second embossing varnish layer is between the orientation-dependent refractive indices of the motif layer in the visible spectrum. Again advantageously, the refractive indices of the first embossing varnish layer and the second embossing varnish layer differ by no more than 0.1, in particular by no more than 0.05, in the visible spectrum.

The alignment structures may also be provided only in the region of the motif layer and in particular in register therewith.

In one advantageous embodiment, the first latent motif contains one or more first image elements and the second latent motif contains a multiplicity of second image elements, wherein the first and second image elements comprise alphanumeric characters, patterns or codes. Advantageously, the second image elements are arranged here in a grid.

The micro-optical relief structure is advantageously formed by a diffractive structure, in particular a one-dimensional or two-dimensional periodic diffractive structure, by a matte structure, by a subwavelength structure, in particular a subwavelength grating or a moth-eye structure, and/or by a non-diffractive microstructure, in particular an arrangement of (directionally reflecting) micromirrors or microlenses.

The invention also includes a data carrier comprising a security element of the type described. The data carrier may in particular be a document of value, such as a banknote, in particular a paper banknote, a polymer banknote or a film composite banknote, a share certificate, a bond certificate, another certificate, a voucher, a cheque, a seal, a tax strip, a high-quality entrance ticket, but also an identity card, such as a credit card, a bank card, a cash payment card, an authorization card, an identity document or a passport personalization page.

Finally, the invention also provides a process for manufacturing a security element of the type described, in which
a first embossing varnish layer is applied to a carrier film so as to form an alignment layer for homogeneously orienting a liquid-crystal material,
the first embossing varnish layer is provided with an embossing in order to produce at least two regions with alignment structures having a different orientation so as to form a second latent motif, and the embossing varnish is cured,
a motif layer based on a nematic liquid-crystal material in the form of a first latent motif is applied, in regions, directly to the first embossing varnish layer and so as to over-lap the regions forming the second latent motif, wherein the nematic liquid-crystal material is aligned by the alignment structures of the motif-forming regions with a different, homogeneous orientation, such that the motif formed by the different alignment structures is discernible when viewed through a polarizer, wherein at least one of the alignment structures of the motif-forming regions forms a grating pattern with grid lines the spacing between which varies over the surface of the motif-forming region, such that the alignment structure forms an aperiodic grating,
the liquid-crystal material is cured by exposure to radiation, and
a single-layer or multilayer second embossing varnish layer is applied over the whole surface of the carrier film with the motif layer, the second embossing varnish layer is provided with an embossing for producing a micro-optical relief structure, and is then provided with a reflection-enhancing coating.

According to one advantageous embodiment of the process, the first embossing varnish layer is embossed without precuring. Preferably, a further varnish layer is applied to the carrier film and at least partially cured before the first embossing varnish layer is applied.

Advantageously, the liquid-crystal material is physically dried before being exposed to radiation. The liquid-crystal material is preferably cured by exposure to UV radiation.

Like the second embossing varnish layer, the first embossing varnish layer is also preferably applied over the whole surface. Particularly advantageously, the first and/or the second embossing varnish layer and/or the motif layer is/are printed.

It is also particularly expedient for the second embossing varnish layer to be metallized and, where applicable, demetallized in regions.

In further advantageous embodiments, one or more further layers, in particular a primer lay-er, a heat-sealing varnish layer, a print-receiving layer and/or a protective layer, is/are ap-plied to the second embossing varnish layer, in particular by printing.

Any isotropic transparent layers may be inserted between the first embossing varnish layer provided with the alignment structures and the motif layer of nematic liquid-crystal material (“liquid-crystal layer structure”) and the second embossing varnish layer provided with the reflection-enhancing coating (“reflector structure”)—and thus in the optical path. Thus, for example, in cases in which the security element is composed of partial elements (liquid-crystal layer structure or reflector structure) that are manufactured separately, an isotropic transparent laminating adhesive may be provided. If for example the intercoat adhesion is not sufficient, a single-layer or two-layer primer structure may also be used. Birefringent films or films whose birefringence is not specified precisely or whose birefringence is strongly wavelength-dependent, between the observer and the reflector, should however be avoided.

### BRIEF DESCRIPTION OF THE DRAWINGS

The invention will be explained in more detail below based on exemplary embodiments with reference to the accompanying figures, which likewise disclose essential features of the invention and the illustration of which is not a true-to-scale and proportional reproduction. These exemplary embodiments serve merely for illustration and should not be interpreted as limiting. For the sake of better understanding, the illustrations in the figures are highly schematic and do not reflect the real circumstances. In order to avoid repetitions, elements that are identical or correspond to one another in different figures are designated by identical reference signs and are not explained repeatedly. In the figures:

FIG. 1 shows a schematic illustration of a banknote with an embedded security thread and an adhesively bonded transfer element,

FIG. 2 shows a cross-sectional view of the structure of a security element according to one exemplary embodiment of the invention,

FIG. 3a shows a view of one exemplary embodiment of a security element having a structured alignment layer and a liquid-crystal layer applied in the form of a motif, and FIG. 3b shows an enlarged view of the alignment structure,

FIG. 4 shows a schematic illustration of a circular polarizer,

FIGS. 5a-5d show views of the security element of FIGS. 3, as it appears when viewed in FIG. 5a without aids, in FIG. 5b when viewed with a circular polarizer, in FIG. 5c when viewed with a linear polarizer in a first position, and in FIG. 5d when viewed with a linear polarizer in a second position rotated in relation to said first position.

### DETAILED DESCRIPTION OF THE INVENTION

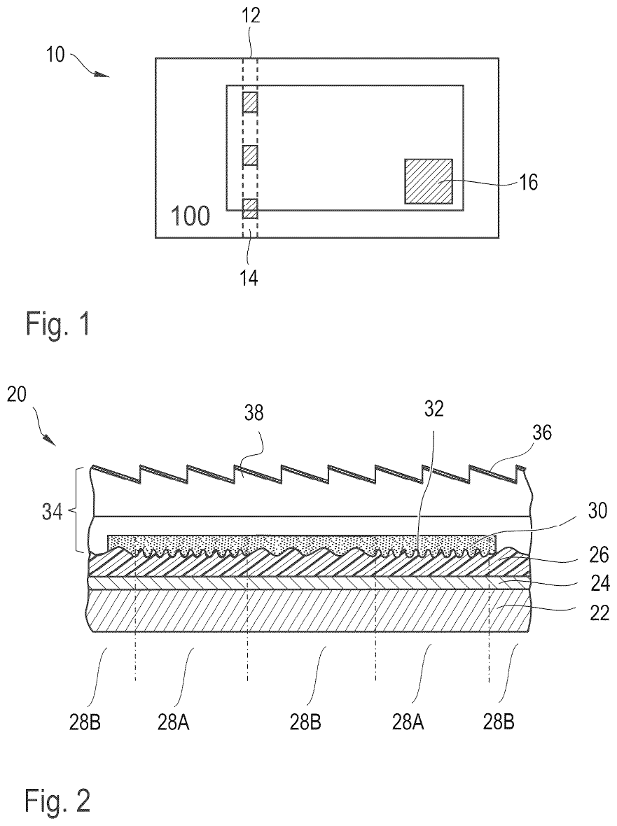

The invention will now be explained using the example of security elements for banknotes. FIG. 1 in this regard shows a schematic illustration of a banknote 10, which is provided with two security elements 12 and 16 according to exemplary embodiments of the invention. The first security element represents a security thread 12, which protrudes on the surface of the banknote 10 at certain window regions 14, while it is embedded inside the banknote 10 in the regions located between said window regions. The second security element is formed by an adhesively bonded transfer element 16 of any shape. Transfer elements may be present in particular as patches or strips, each with or without its own carrier layer. The security element 16 may also be designed in the form of a cover film that is arranged over a window region or a continuous opening of the banknote.

The structure and the manufacture of a security element 20 according to a first exemplary embodiment will now be explained in more detail with reference to the cross section of FIG. 2.

The basis of the security element 20 is a high-quality stretched PET carrier film 22 to which a thin layer 24 of a UV-curable varnish is applied over the whole surface in the exemplary embodiment. A UV-curable embossing varnish 26 is applied to the (partially or fully cured) varnish layer 24 over the whole surface, and is embossed as far as possible without precuring in what is known as the casting.

The subregions 28A, 28B are each provided with an alignment structure 32 over the whole surface. The alignment structure 32 consists, in regions, of a multiplicity of parallel grooves that are arranged next to one another, have varying spacings and allow for orientation of liquid-crystal molecules. By way of example, these grooves in the subregions 28A and 28B each form an aperiodic grating having an average period length of 0.2 μm to 2.0 μm, prefer-ably of 350 nm to 800 nm, and a profile depth of 200 nm to 600 nm. Lower profile depths are also conceivable, for example in the region of 50 nm. The longitudinal direction of these grooves in this case represents the orientation direction of the alignment structure in the sub-regions 28A and 28B.

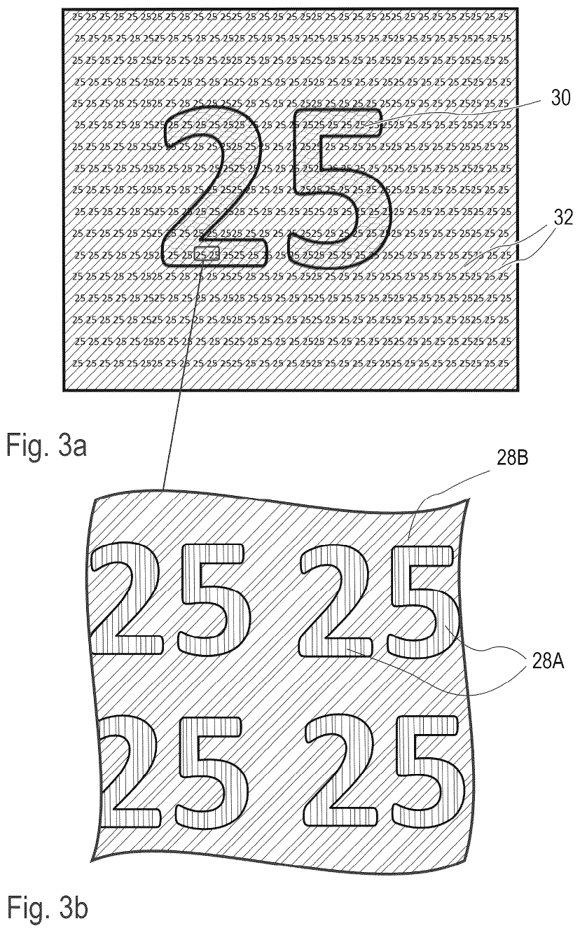

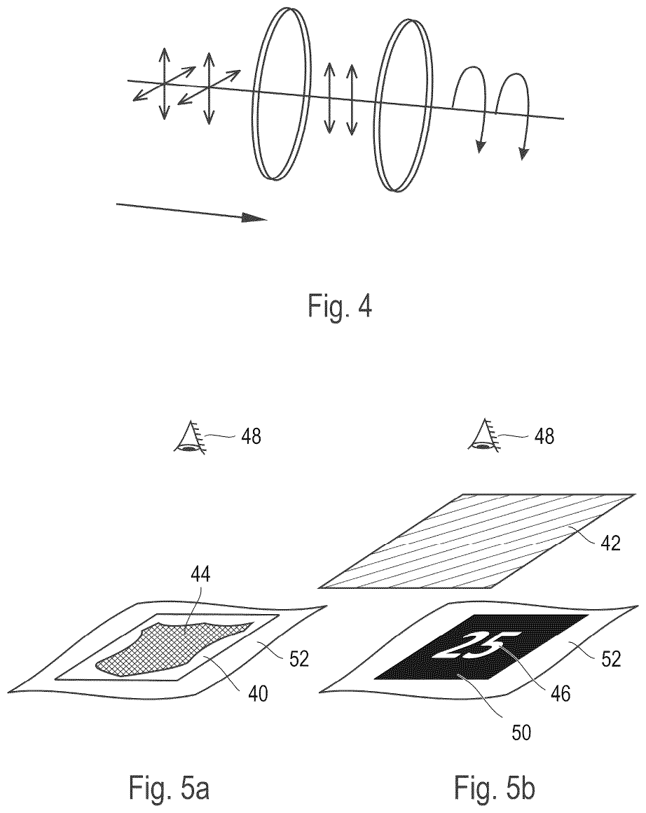

As may be seen from the illustration of FIGS. 2 and 3, the orientation direction of the alignment structure 32 in the subregions 28A and 28B is different. By way of example, the subregion 28A thus has a multiplicity of vertically arranged parallel grooves, and the subregion 28B has a multiplicity of parallel grooves that are rotated by 45° relative to the vertical. The parallel grooves are provided here with a varying spacing (indicated by the hatching in FIG. 3b). The aperiodic arrangement of the grooves reliably prevents constructive interference of the light reflected at adjacent grid lines, and thus the formation of a superimposed diffraction pattern, in particular in the regions of the liquid-crystal material.

In the case of an alignment structure formed as a periodic grating, such effects may occur there for instance when the security element is tilted to a large extent. In the case of a periodic arrangement, the grid lines are arranged on the grid points of a regular grid. In the regions in which the UV-curable embossing varnish 26 is coated directly with a single-layer or multi-layer embossing varnish structure 34 the refractive index of which does not differ or differs only slightly from that of the UV-curable embossing varnish 26 in the visible spectrum, in particular by no more than 0.1, any diffraction effects are substantially cancelled out. How-ever, more or less pronounced diffraction effects may very well be observed in the regions of the security element that are provided with nematic liquid-crystal material, in particular when the security element is tilted to a large extent. Such behaviour is undesirable for a latent security feature.

Without being bound to this explanation, the orientation-related different refractive indices of the liquid-crystal material are presumed responsible for this. The liquid crystals thus have a different refractive index along the original molecules than they do transverse thereto (for example n=1.57, with Δn=0.14). This means that, in the case of targeted alignment of the liquid-crystal material, its refractive index differs significantly from that of the adjoining UV-curable embossing varnish 26, at least at certain angles, and so a jump in refractive index may occur even in the case of mutually coordinated refractive indices (for instance by virtue of the refractive index of the UV embossing varnish 26 being selected such that its refractive index is between the two orientation-dependent refractive indices of the liquid-crystal layer 30). In this case, the liquid-crystal material has an effect similar to an HRI coating.

Unlike a periodic arrangement, in the case of the aperiodic arrangement according to the invention of the grid lines, there is no simple, regular relationship between the spacings between adjacent grid lines. This reliably prevents constructive interference of the light reflected at adjacent grid lines, and thus the formation of a superimposed diffraction pattern.

It has also become apparent that the aligning properties of the alignment structures are not affected by the aperiodic arrangement of the grid lines, which are formed as grooves in the exemplary embodiment.

In the exemplary embodiment, the subregion 28A is arranged in a grid shape in the form of a multiplicity of repeating image elements (small “25”) in front of the background, formed by the subregion 28B, with another aligning orientation (“wallpaper motif”) (rotated here by 45° relative thereto).

A thin layer 30 of a nematic liquid-crystal material is applied in a motif form (large “25”) to the alignment structure 32, in particular by printing. For increased edge sharpness, it may be advantageous to apply the edges or borders of the motif with reduced grammage.

The motif applied with the aid of the liquid-crystal material may advantageously be present with a high coated thickness. In particular, the dimensions of the image elements produced by the liquid-crystal material 30 may be selected such that they are significantly greater, preferably greater by a multiple, than the dimensions of the image elements formed by the subregion 28A of the alignment structure 32.

After the liquid-crystal layer 30 has been applied, the nematic liquid crystals in the subregions 28A, 28B orient themselves homogeneously in accordance with the specification of the alignment structure 32. The liquid-crystal motif layer 30 thus has regions, corresponding to the subregions 28A, 28B, in which the orientation of the liquid crystals differs. The resulting alignment is fixed, where applicable after physical drying in order to remove any solvents, by crosslinking the liquid-crystal layer 30 with UV irradiation.

A single-layer or multilayer embossing varnish structure 34 is applied to the obtained layer sequence. A relief structure 38, for example a hologram structure, a micromirror structure and/or a subwavelength grating, is embossed therein, and is then provided with a reflection-enhancing coating, for example a metallization 36. Recesses (not shown), for example in the form of a negative type, may be introduced into the preferably vapour-deposited metal layer 36 (for example of aluminum) by partial demetallization.

The recesses may be produced with the aid of an etching process or a washing process. When employing a washing process, soluble wash inks are printed before the metal layer is applied, and, after vaporization, are washed off together with the substances of the PVD layer that are deposited thereon. When employing an etching process, the PVD coating process is carried out first, followed by printing and structuring of a resist. The PVD layer is then removed by an etchant at the unprotected locations. The remaining resist may remain on the PVD layer or be removed by employing suitable solvents.

As an alternative to metal layers, the relief structure 38 may also be provided with a high-refractive-index layer. Examples of suitable high-refractive-index materials are CaS, Cr02, ZnS, Ti02 or SiOx. Thin-film elements having a colour tilt effect may likewise also be applied to the relief structure 38 by way of a PVD coating process and, where applicable, provided with recesses. Such thin-film elements are based in particular on viewing angle-dependent interference effects caused by multiple reflections in the various sublayers of the element.

The product obtained may be provided directly with a primer layer (not illustrated) and heat-sealing varnish and for example applied to a substrate 52, for example paper. The carrier film 22 may in this case be removed after application to the substrate 52 or remain in the structure as a cover film. The latter designs are used in particular in the application of security elements that are intended to cover through-openings in the article to be safeguarded. By way of example, in the case of a T-LEAD (Longlasting Economical Anticopy Device) strip (where T stands for “Transfer”), unlike an L-LEAD strip, a carrier film that may already be present is thus generally removed after application to the security paper or document of value. L-LEAD designs are used in particular in the application of security elements that are intended to cover through-openings in the article to be safeguarded.

Before the heat-sealing varnish is applied, further machine-readable and/or decorative layers may also be applied to the possibly partially demetallized embossing varnish layer 34, in particular including so as to overlap the metallization 36. The heat-sealing varnish may further-more contain machine-readable feature substances, such as for example magnetic, electrically conductive, phosphorescent or fluorescent substances.

Any isotropic transparent layers may also be inserted between the embossing varnish 26 pro-vided with the alignment structure 32 and the liquid-crystal layer 30 (“liquid-crystal layer structure”) and the second embossing varnish structure 34 provided with the metallization 36 as a reflection-enhancing coating (“reflector structure”)—and thus in the optical path. Thus, for example, in cases in which the security element 20 is composed of partial elements (liquid-crystal layer structure or reflector structure) that are manufactured separately, an isotropic transparent laminating adhesive may be provided. If for example the intercoat adhesion is not sufficient, a single-layer or two-layer primer structure may also be used.

As an alternative, the layer structure may also be processed further, for example to form what is known as a patch or individual security element. For this purpose, a further film, for example a PET film with a low thickness (for example 6 μm), may be laminated onto the layer structure. A support film for the cutting or punching process that possibly takes place may then be laminated onto the side of the carrier film 22, while the surface of said thin PET film may be provided with primer and heat-sealing varnish. Following pre-cutting or punching of the outlines and stripping, the prefabricated individual security elements (patches) may then be applied to a substrate. Processes for manufacturing such a security element transfer mate-rial and processes for transferring a security element from the security element transfer mate-rial to an article of value are described for example in document WO 2010/031543 A1, the disclosure of which is incorporated to this extent into the present application.

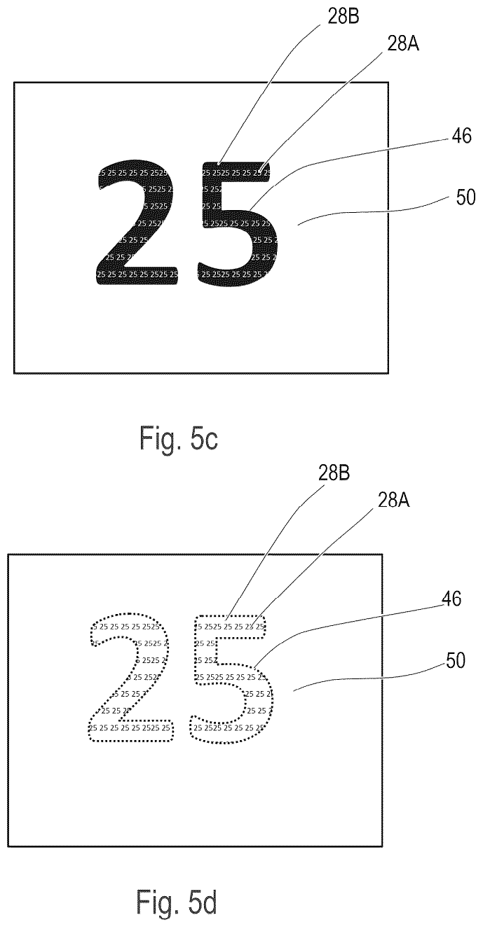

FIG. 5a shows a view of a single security element 40 as it appears when viewed without aids. When viewed without aids, the security element 40 exhibits the appearance of a shiny metal optically variable microstructure, in the exemplary embodiment a relief image 44 in the form of a coat of arms (FIG. 5a) produced with the aid of micromirrors.

When viewing such a security element 40 with a circular polarization filter 42, the image motif 46 produced by the liquid-crystal layer 30 may be made visible and appears, in this region, in the form of the bright character “25” on a dark background 50 (FIG. 5b). Rotating the polarization filter 42 does not change the appearance.

A further motif may be made visible when viewing the security element with a linear polarization filter (not illustrated) (or a circular polarization filter viewed through the rear, that is to say “reversed”). In this case, the metal-coated regions without the liquid-crystal layer-regardless of the position of the linear polarization filter-always appear bright, while the viewer 48, in a first orientation of the linear polarization filter in the region of the liquid-crystal layer, perceives the subregion 28B as a large dark image element (large “25”) and the region 28A as a bright motif in the form of small image elements (small “25”) arranged in a grid (FIG. 5c).

When the linear polarization filter is rotated, the relative brightnesses change and are re-versed in the event of a rotation by 45° in the region of the liquid-crystal layer 30, such that the small image elements formed by the region 28A then become visible as a dark motif the outline of which, indicated by a dashed line, is predetermined by the region of the liquid-crystal layer 30. The background corresponding to the subregion 28B appears in the form of the image motif 46 without contrast or with only slight contrast in relation to the background 50, which is not provided with the liquid-crystal layer 30 and likewise appears bright, of the security element 40 (FIG. 5d). The small characters (small “25”) are used here to define the larger character (large “25”).

One particular advantage of the described designs is that they contain different latent motifs, which may be made visible depending on the choice of the polarization filter used as an aid. In particular, in addition to a “macroscopic”, easily discernible motif, very sharply delimited “microscopic” motifs may also be produced, since the resolution of the polarizing motif is no longer determined solely by the printing accuracy, but also by the accuracy of the structuring of the embossing varnish layer.

Moreover, the aperiodic arrangement of the alignment structures or the variation of the spacing between the grid lines forming the alignment structures effectively prevents any interfering diffraction effects that could otherwise lead, in some viewing situations, to undesirable visibility of the latent motif produced with the nematic liquid-crystal material. Surprisingly, it has also become apparent that the aligning properties of the alignment structures are not affected by the aperiodic arrangement present in the form of a variation of the spacings.

The invention also offers a visually more interesting image than known latent security features based on liquid crystals. If a security element is of interest to the viewer, this increases the likelihood of them paying more attention to the security element and the article of value provided therewith, which in turn leads to a greater security effect.

Since the different motifs may be confusing depending on the side of the (circular) polarizing filter through which the security element is viewed, the expected motif may be reproduced in stylized form on the polarization filter used as verification medium on the respective top side. Both of the motifs able to be achieved by rotation may also be reproduced in stylized form on that side of a circular polarization filter that corresponds to a linear polarization filter in terms of its effect (“reversed” circular polarization filter) or in the case of a linear polarization filter.

For a verification, incident light and emergent light must in principle be/have been polarized here, which may be achieved by applying a polarization filter. Other variations are also conceivable, however. By way of example, the light source illuminating the viewing region may emit polarized light. Under these circumstances, the viewer may use the polarization filter, for example in the form of polarizing glasses, at any point between themselves and the article to be verified.

The (optically important) working steps in the manufacture of the security element begin with the first embossing. The motif consisting of nematic liquid-crystal material 30 is applied to the alignment structure 32 thereby produced, in particular by printing. The alignment structure 32 is filled by the nematic liquid crystals in this region (profile depth of the alignment structure for example 200 nm, layer thickness of the nematic liquid-crystal layer for example 1 μm). When the refractive index of the UV embossing varnish 26 is selected appropriately, the embossing structure disappears optically.

Ideally, the refractive indices of the adjoining materials are matched to one another so as not to give rise to any significant jumps in refractive index that would make the motif of the alignment structure visible even without aids, and thus permanently. Since liquid-crystal layers have an orientation-dependent refractive index, the UV embossing varnish 26 should preferably be chosen such that its refractive index is between the two orientation-dependent refractive indices of the liquid-crystal layer 30.

If it is not desirable to be able to discern the nematic liquid-crystal layer when viewing the security element without aids, the alignment quality of the alignment structure 32 should also be comparable in all regions 28A, 28B.

In the operation following the coating with liquid-crystal material, a UV embossing varnish 34 is applied (in two stages in the exemplary embodiment) over the whole surface for the actual embossing, for example of a hologram or micromirror motif 44. This means that the nematic liquid-crystal layer 30 is embedded between UV varnish layers. In addition to the nematic motif, the embossing varnish layer 34 is applied directly to the existing embossing 32 or the embossing varnish 26. If the refractive indices are similar, that is to say differ by no more than 0.1 and in particular by no more than 0.05 in the visible spectrum, the “alignment” embossing or alignment structure 32 also disappears optically here.

The liquid-crystal layer 30 and the second embossing varnish structure 34 may have refractive indices that deviate. Ideally, the refractive indices are matched to one another in this case too so that no significant jumps in refractive index occur.

It is possible to limit the first embossing to the region in which the nematic liquid-crystal material is intended to be or could be printed (register inaccuracies). However, this limiting requires an insetter operation when printing the liquid-crystal material, which may entail in-creased scrap.

Irrespective of this, an insetter operation may also be necessary to avoid the welds (embossing tool with alignment motif and embossing tool with relief structure motif) getting into the motif and causing problems for one another due to their structure.

1. A security element for safeguarding articles of value, having a motif layer based on a liquid-crystal material, which is designed and intended to form a latent motif, the security element comprising:
a first embossing varnish layer arranged on a carrier film, a motif layer that is partially present on the first embossing varnish layer and is based on a nematic liquid-crystal material, and a single-layer or multilayer second embossing varnish layer present over the whole surface;
wherein the surface of the first embossing varnish layer that faces the nematic liquid-crystal material is provided with an embossing that has at least two regions with alignment structures having a different orientation so as to form a second latent motif;
wherein at least one of the alignment structures of the motif-forming regions forms a grating pattern comprising grid lines the spacing between which varies over the sur-face of the motif-forming region, such that the alignment structure forms an aperiodic grating;
wherein the motif layer is arranged, in the form of a first latent motif, in regions, directly on the first embossing varnish layer and so as to overlap the regions forming the second latent motif, wherein the nematic liquid-crystal material is aligned homogeneously by the motif-forming regions in the form of the second latent motif with a respective different orientation, such that the motif formed by the different alignment structures is discernible when viewed through a polarizer; and
wherein the second embossing varnish layer is provided with an embossing for producing a micro-optical relief structure and a reflection-enhancing coating.

2. The security element according to claim 1, wherein all alignment structures of the motif-forming regions each form a grating pattern comprising grid lines the spacing between which varies over the surface of the motif-forming region, such that the alignment structure forms an aperiodic grating.

3. The security element according to claim 1, wherein the alignment structures are in the form of fine grooves or channels by way of which the molecules of the nematic liquid-crystal material are aligned.

4. The security element according to claim 1, wherein the aperiodic grating has an average period length of 0.2 μm to 2.0 μm, and a profile depth of 50 nm to 600 nm.

5. The security element according to claim 1, wherein the spacing between the grid lines varies in line with a random number distribution or a pseudorandom number distribution.

6. The security element according to claim 1, wherein the embossing of the first embossing varnish layer for forming the second latent motif has two regions with alignment structures having different orientation directions, wherein the orientation directions assume angles relative to one another selected from the group consisting of 45° and 135°.

7. The security element according to claim 1, wherein the first embossing varnish layer is present over the whole surface.

8. The security element according to claim 1, wherein the refractive index of the first and/or of the second embossing varnish layer is in the visible spectrum between the orientation-dependent refractive indices of the motif layer.

9. The security element according to claim 1, wherein the refractive indices of the first embossing varnish layer and the second embossing varnish layer differ by no more than 0.1, in particular by no more than 0.05, in the visible spectrum.

10. The security element according to claim 1, wherein the first latent motif contains one or more first image elements and the second latent motif contains a multiplicity of second image elements, wherein the first and second image elements comprise alphanumeric characters, patterns or codes, wherein the second image elements are arranged in a grid.

11. The security element according to claim 1, wherein the micro-optical relief structure is formed by a diffractive structure, in particular a one-dimensional or two-dimensional periodic diffractive structure, by a matte structure, by a subwavelength structure, in particular a subwavelength grating or a moth-eye structure, and/or by a non-diffractive microstructure, in particular an arrangement of micromirrors or microlenses.

12. A data carrier comprising a security element according to claim 1, wherein the data carrier is in particular a document of value or an identity card.

13. A process for manufacturing a security element for safeguarding articles of value, having a motif layer of liquid-crystal material, which is designed and intended to produce a la-tent motif, wherein, in the process,
a first embossing varnish layer is applied to a carrier film so as to form an alignment layer for homogeneously orienting a liquid-crystal material,
the first embossing varnish layer is provided with an embossing in order to produce at least two regions with alignment structures having a different orientation so as to form a second latent motif, and the embossing varnish is cured,
a motif layer based on a nematic liquid-crystal material in the form of a first latent motif is applied, in regions, directly to the first embossing varnish layer and so as to over-lap the regions forming the second latent motif, wherein the nematic liquid-crystal material is aligned by the alignment structures of the motif-forming regions with a different, homogeneous orientation, such that the motif formed by the different alignment structures is discernible when viewed through a polarizer, wherein at least one of the alignment structures of the motif-forming regions forms a grating pattern with grid lines the spacing between which varies over the surface of the motif-forming region, such that the alignment structure forms an aperiodic grating,
the nematic liquid-crystal material is cured by exposure to radiation, and
a single-layer or multilayer second embossing varnish layer is applied over the whole surface of the carrier film with the motif layer, the second embossing varnish layer is provided with an embossing for producing a micro-optical relief structure, and is then provided with a reflection-enhancing coating.

14. The process according to claim 13, wherein the first embossing varnish layer is embossed without precuring, wherein a further varnish layer is applied to the carrier film and at least partially cured before the first embossing varnish layer is applied.

15. The process according to claim 13, wherein the liquid-crystal material is physically dried before being exposed to radiation.

16. The process according to claim 13, wherein the first embossing varnish layer is applied over the whole surface.
